(19) United States
(12) Patent Application Publication
(10) Pub. No.: US 2007/0024962 A1
(43) Pub. Date: Feb. 1, 2007

(54) METHOD FOR THE DETERMINATION OF CONFIGURATION-DEPENDENT AND STATE-DEPENDENT MICROSCOPE PARAMETERS

(75) Inventors: STEFAN STEINBORN, Bovenden (DE); Steffen Leidenbach, Gleichen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Carl Zeiss Jena GmbH

(21) Appl. No.: 11/457,194

(22) Filed: Jul. 13, 2006

(30) Foreign Application Priority Data
Jul. 27, 2005 (DE) 10 2005 036 143.9

(51) Int. Cl. G02B 21/00

(52) U.S. Cl. 359/368; 359/900

(57) ABSTRACT

In a method for determining configuration-dependent and state-dependent microscope parameters which are influenced by a plurality of microscope components that are arranged in the optical path of a microscope, it is the object of the invention to design the quantification method for the microscope parameters in a universally usable manner, i.e., so as to be applicable in an improved manner for microscopes of different constructions. After preparing a microscope-specific tree structure of the optical paths which proceeds from an object to be observed and extends from the start of the illumination beam paths to the end of the observation beam paths, the positions of the microscope components in the tree structure and components preceding and succeeding each of the microscope components are determined. Proceeding from a starting point in the tree structure, the degree of influence exerted on the microscope parameter to be determined is determined recursively along a chain of preceding components or succeeding components as a partial contribution for each microscope component exerting an influence in order to determine from the partial contributions the total influence exerted on the microscope parameter by the microscope components.

### CROSS-REFERENCE TO RELATED APPLICATION

This application claims priority of German Application No. 10 2005 036 143.9, filed Jul. 27, 2005, the complete disclosure of which is hereby incorporated by reference.

### BACKGROUND OF THE INVENTION

a) Field of the Invention

The invention is directed to a method for determining configuration-dependent and state-dependent microscope parameters which are influenced by a plurality of microscope components that are arranged in the optical path of a microscope.

b) Object and Summary of the Invention

The properties of components of a microscope that are arranged between the light source and the object to be observed and between the object to be observed and the observation outputs influence the light and, therefore, the illumination and imaging of the object.

On the one hand, this influence must be quantified for purposes of monitoring the state of microscope components and for an automated control and regulation of the microscope components so that, finally, the analyses conducted with the microscope can also be documented.

On the other hand, a quantification in which the total effect upon a parameter depending upon different microscope components, e.g., total magnification, must be determined requires detailed knowledge of the individual hardware components of the microscope because microscopes can differ from one another with respect to construction or can have different observation options such as eyepiece viewing or a camera receptacle. Further, the existing microscope components that actually influence the parameters in question in a current state of the microscope must be known.

For these reasons, difficulties arise in providing a quantification method that is tailored to different microscope configurations. Therefore, it is the object of the invention to solve this problem, in particular to design the quantification method so as to universally usable, i.e., so as to be applicable in an improved manner for microscopes of different constructions.

According to the invention, this object is met through a method for the determination of configuration-dependent and state-dependent microscope parameters which are influenced by a plurality of microscope components arranged in the optical path of the microscope, in which a microscope-specific tree structure of the optical paths which proceeds from an object to be observed and extends from the start of the illumination beam paths to the end of the observation beam paths is first prepared, whereupon the positions of the microscope components in the tree structure and components preceding and succeeding each of the microscope components are determined, and in which, proceeding from a starting point in the tree structure, the degree of influence exerted on the microscope parameter to be determined is determined along a chain of preceding components and succeeding components as a partial contribution for each microscope component exerting an influence in order to determine from the partial contributions the total influence exerted on the microscope parameter by the microscope components.

By means of a microscope-specific optical path structure which is prepared as a tree structure, and by means of the positions of the microscope components determined therein, and with knowledge of the preceding components and succeeding components and the influences exerted by the latter in the optical path, e.g., a reduction in light caused by filtering or influence exerted on the magnification of the image, algorithms for parameter determination can be formulated in a generalized manner without having to change the definition of the microscope components that are defined specifically for each microscope type.

Since it is necessary to run through the tree structure from every point to a destination in a definite manner, a system-wide transmission of information is no longer necessary when defining the microscope components. The microscope components upon which magnification depends, for example, need not be made known to the eyepiece. Instead, it is sufficient for the eyepiece to know only the preceding component in the tree structure which latter, in turn, knows the component preceding it.

In the method according to the invention, exclusively the characteristic of a current microscope component is checked in the tree structure. The checking results for the microscope components are detected and processed successively .

To determine the total effect on a microscope parameter that is dependent on a plurality of microscope components, e.g., in the observation beam path, the chain of preceding components is ran through beginning with the observation output of interest. Since every microscope component influencing the microscope parameters reports the degree of influence to a central computer, the total effect on a microscope parameter is determined from the reported degrees of influence when the recursive process reaches the object to be observed. Correspondingly, in the illumination beam path the chain of preceding components is traced back to the illumination device.

For example, in order to determine the total magnification at the end of an observation beam path of the microscope components arranged in the tree structure of the observation beam path, the degree of influence exerted on the magnification proceeding from the end of the observation beam path to the object is determined recursively as partial magnifications which, multiplied together, give the total magnification.

Determination of the transmitted light for the illumination of the object to be examined can be carried out in that the degree of influence exerted on the transmission by the microscope components arranged in the tree structure of the illumination beam path is determined recursively proceeding from the object to the lamp as partial transmissions which, multiplied together, give the total transmission.

By recursive checking of the microscope components in the tree structure and of an incident illumination beam path and transmitted illumination beam path, it can be determined to what extent the existing lamps contribute to the illumination of the object. Further, it is known whether the object is illuminated by incident light or transmitted light.

This offers the advantage that the brightness of the object can be maintained constant when switching between different lamps, e.g., in order to prevent dazzling of the observer.

Further, the determined values of the illumination contribution and/or of the observation can be used as input parameters for a light manager which controls the microscope components as a function of the observation conditions and illumination conditions.

When the degree of influence of a microscope component on a microscope parameter changes, the parameter change is sent to the succeeding component, wherein the partial effects of the preceding components on the microscope parameter up to the microscope component in which the degree of influence on a microscope parameter changes are taken into account when determining the total influence exerted on the microscope parameter.

Other microscope parameters aside from magnification and transmission, e.g., polarization and spectral transmission, can also be determined by the method according to the invention. While the total polarization is given by summing the partial contributions to polarization that are determined recursively along the chain of preceding components, the total spectral transmission is determined by multiplying the partial contributions to transmission for individual wavelengths or wavelength regions which are determined recursively along the chain of preceding components.

When determining polarization, the extinction position of the analyzer, for example, can be corrected when a component changes in the beam path. The process of determining the spectral transmission allows an automated light regulation to be used also for fluorescence microscopy.

The invention will be described more fully in the following with reference to the schematic drawings.

### BRIEF DESCRIPTION OF THE DRAWINGS

In the drawings:

FIG. 1 shows an observation beam path modeled as a tree structure;

FIG. 2 shows a transmitted light beam path modeled as a tree structure;

FIG. 3 shows an incident light beam path modeled as a tree structure; and

FIG. 4 shows a microscope having a controlling and evaluating unit provided for carrying out the method according to the invention.

### DESCRIPTION OF THE PREFERRED EMBODIMENTS

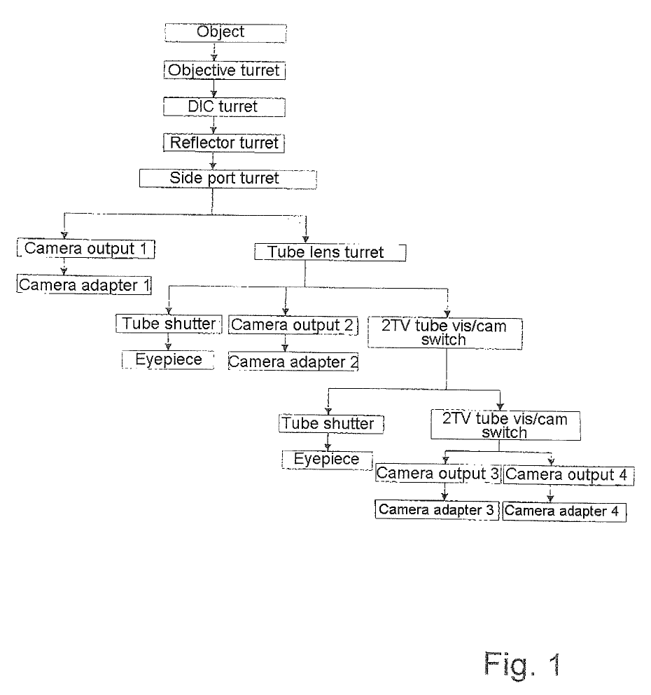

Corresponding to the optical path structure of the observation beam path shown in FIG. 1 as a tree structure, the chain of preceding components is run through starting from the observation beam path of interest in order to determine the total effect on a microscope parameter depending on a plurality of microscope components. Every microscope component influencing the microscope parameter sends a report about the degree of influence. When the recursive process reaches the object to be observed, the total effect on the microscope parameter is known.

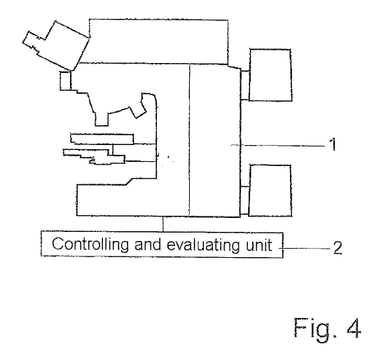

Since some of the microscope components are those belonging to an automated microscope designated by 1 in FIG. 4, these components are coded, motorized, and have an independent intelligence in the form of a control unit (processor) which can read out and detect the current positions and states and is connected to a central controlling and evaluating unit 2 which receives, stores, and processes the information sent by the control unit to carry out the method according to the invention.

### EXAMPLE 1a

Determination of the current total magnification at the eyepiece

Starting at the eyepiece, the magnification for all preceding components is determined recursively in order to calculate the total magnification from the magnification values of the individual components that are multiplied together.

For example, there is an effective total magnification of 500x at the eyepiece when the recursively interrogated microscope components have the following magnification values:

Eyepiece (10×, total: 10×)→tube shutter (1×, total: 10×)→2TV tube visualization/camera switch (1×, total: 10×)→tube lens turret (1.25×, total: 12.5×)→side port turret (1×, total: 12.5×)→. . . →objective turret (40×, total: 500×)→object (total: 500×).

### EXAMPLE 1b

Determination of the current total magnification at the camera adapter 1

With the same algorithm as that used in Example 1a, starting at the camera adapter 1 the magnification for all preceding components is determined recursively in order to calculate the total magnification from the magnification values of the individual components that are multiplied together.

Camera adapter 1 (1.6×, total: 1.6×)→camera output 1 (1.0×, total: 1.6×)→side port turret (1×, total: 1.6×)→. . . →objective turret (40×, total: 64×)→object (total: 64×).

This results in a total magnification of 64× at the camera output 1 in the same state of the microscope as that in Example 1a.

When the degree of influence of a microscope component on a microscope parameter changes, the parameter change is sent via the succeeding components so that the total influence exerted on the microscope parameter can be determined by the changed degree of influence.

### EXAMPLE 2

Objective turret changes the magnification from 40×to 5×

The change in magnification is sent from the objective turret to its succeeding component, the DIC turret, which in turn reports to its succeeding component (reflector turret). The information is transmitted within the chain of succeeding components until all observation outputs are reached.

Analogous to the first example, the magnification of every microscope component is taken into account so that the total magnification is available at the ends of the branches of the tree structure.

This type of determination of the total effect on a microscope parameter assumes that the partial effects of the preceding components on the microscope parameter are taken into account up to the microscope component at which the degree of influence on a microscope parameter changes.

When the eyepiece serves as an observation output, the following algorithm results:

Objective turret (40×→5×, total: 40×/40×*5×=5×) DIC turret (1×, total: 5×)→. . . →side port turret (1×, total: 5×)→tube lens turret (1.25×, total: 6.25×)→. . . →eyepiece (10×, total: 62.5×)

The effective total magnification at the eyepiece is 62.5×.

the change in the degree of influence exerted on the microscope parameter is not only effective in the branch of the eyepiece, information is also transmitted to the other observation outputs with the result that, e.g., at the camera adapter 1, a total magnification of 8×is present.

Objective turret (40×→5×, total: 40×/40×*5×=5×) DIC turret (1×, total: 5×) . . . →side port turret (1×, total: 5×)→camera output 1 (1×, total: 5×) camera adapter 1 (1.6×, total: 8×).

### EXAMPLE 3

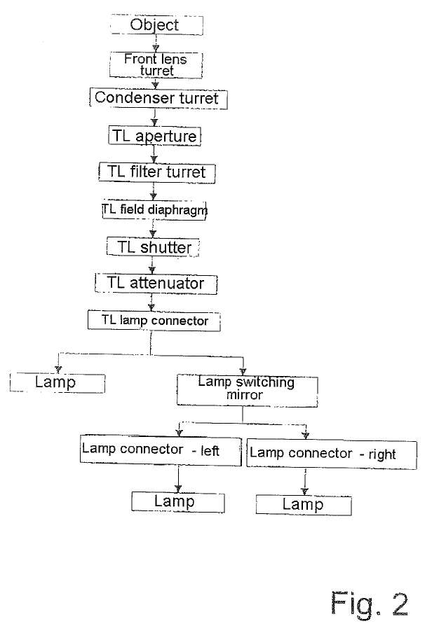

In Example 3, referring to FIG. 2, the transmitted light for the illumination of the object to be examined will be determined for a lamp connected to the TL lamp connection piece in the transmitted light beam path.

Proceeding from the object, the branches of the illumination beam paths are rim through recursively up to the lamps, and the contributions of the microscope components to the transmission are multiplied together. In this way, the proportion of the incident light reaching the object can be determined for each lamp. Further, when the lamp intensity is known, it can be determined how the object is illuminated (incident light, transmitted light, HAL, HBO . . . ).

Object (100%, total: 100%) front lens turret (95%, total: 95%)→condenser turret (100%, total: 95%)→TL aperture (100%, total: 95%)→TL filter turret (25%, total: 23.75%)→TL field diaphragm (100%, total: 23:75%)→TL attenuator (70%, total: 16.7%)→TL lamp connection piece (95%, total: 15.8%).

Accordingly, 15.8% of the light from a lamp connected to a TL lamp connection piece reaches the object.

When a certain lamp must illuminate the object, the branch of the preceding components can be run through recursively proceeding from this lamp. The microscope components located in the branch can be switched in such a way based on the information contained in the microscope component that the light reaches the object.

### EXAMPLE 4

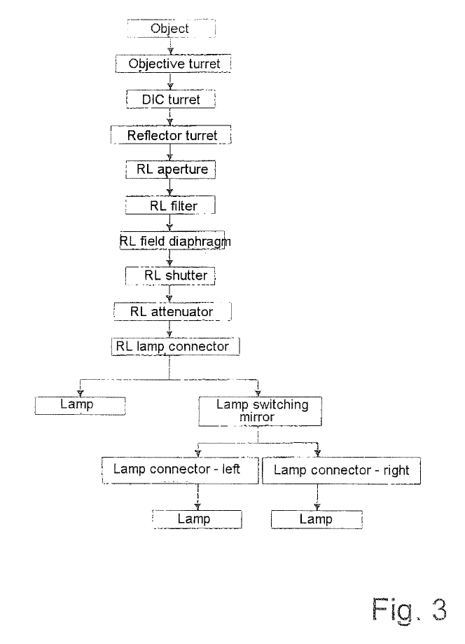

If the lamp at the lamp connection piece on the right-hand side must illuminate the object, the following algorithm results corresponding to FIG. 3:

Lamp→right-hand lamp mirror connection piece→lamp switching mirror (switches to the right-hand lamp mirror connection piece)→RL lamp connection piece (switches to lamp switching mirror)→RL attenuator→. . . →object.

Result: the object is illuminated.

on the examples described above, it is also particularly clear that the method according to the invention provides a generally applicable order principle by which specific structural adaptations can be carried out in the tree structures by adding, canceling, and changing nodes.

the foregoing description and drawings represent the present invention, it will be obvious to those skilled in the art that various changes may be made therein without departing from the true spirit and scope of the present invention.

What is claimed is:

1. A method for the determination of configuration-dependent and state-dependent microscope parameters which are influenced by a plurality of microscope components arranged in the optical path of a microscope, comprising the steps of:
first, preparing a microscope-specific tree structure of the optical paths which proceeds from an object to be observed and extends from the start of the illumination beam paths to the end of the observation beam paths;
determining the positions of the microscope components in the tree structure and components preceding and succeeding each of the microscope components; and
proceeding from a starting point in the tree structure, determining the degree of influence exerted on the microscope parameter to be determined along a chain of preceding components or succeeding components as a partial contribution for each microscope component exerting an influence in order to determine from the partial contributions the total influence exerted on the microscope parameter by the microscope components.

2. The method according to claim 1, wherein, in order to determine the total magnification at the end of an observation beam path of the microscope components arranged in the tree structure of the observation beam path, the degree of influence exerted on the magnification proceeding from the end of the observation beam path to the object is determined recursively as partial magnifications which, multiplied together, give the total magnification.

3. The method according to claim 1, wherein, in order to determine the transmitted light for the illumination of the object to be examined, the degree of influence exerted on the transmission by the microscope components arranged in the tree structure of the illumination beam path is determined recursively proceeding from the object to the lamp as partial transmissions which, multiplied together, give the total transmission.

4. The method according to claim 1, wherein the partial contributions to polarization determined recursively along the chain of preceding components are summed in order to determine the total polarization.

5. The method according to claim 1, wherein the partial contributions to transmission for individual wavelengths or wavelength regions which are determined recursively along the chain of preceding components are multiplied in order to determine the total spectral transmission.

6. The method according to claim 1, wherein, when the degree of influence of a microscope component on a microscope parameter changes, the parameter change is sent to the succeeding component, wherein the partial effects of the preceding components on the microscope parameter up to the microscope component in winch the degree of influence on a microscope parameter changes are taken into account when determining the total influence exerted on the microscope parameter.

7. The method according to claim 1, wherein the determined values for the total influence exerted on a microscope parameter of the illumination and/or of the observation of the illumination contribution and of the observation are used as input parameters for a light manager which controls microscope components as a function of the observation conditions and illumination conditions.

8. A microscope comprising a controlling and evaluating unit for implementing the method according to claim 1.
